(19) United States
(12) Patent Application Publication
(10) Pub. No.: US 2024/0313254 A1
(43) Pub. Date: Sep. 19, 2024

(54) JELLY-ROLL ELECTRODE ASSEMBLY AND SECONDARY BATTERY COMPRISING THE SAME

(71) Applicant: LG ENERGY SOLUTION, LTD., Seoul (KR)

(72) Inventors: Inbok PARK, Daejeon (KR); Kwan Won KIM, Daejeon (KR)

(73) Assignee: LG ENERGY SOLUTION, LTD., Seoul (KR)

(21) Appl. No.: 18/278,794

(22) PCT Filed: Nov. 24, 2022
(86) PCT No.: PCT/KR2022/018725

§ 371 Date: Aug. 24, 2023

(30) Foreign Application Priority Data
Nov. 24, 2021 (KR) 10-2021-0163386
Nov. 23, 2022 (KR) 10-2022-0158762

(51) Int. Cl. H01M 10/04; H01M 50/242; H01M 50/595

(52) U.S. Cl. CPC H01M 10/0431; H01M 10/0422; H01M 50/242; H01M 50/595

(57) ABSTRACT

According to one embodiment of the present disclosure, a jelly-roll electrode assembly in which a cathode sheet, an anode sheet, and a separator interposed between the cathode sheet and the anode sheet are wound together, wherein the outermost side of the jelly-roll electrode assembly is wound with a non-coated portion on which no active material layer is formed on the anode sheet, wherein in the non-coated portion of the anode sheet, a swelling tape is attached to the inner surface toward the central part of the jelly-roll electrode assembly, and wherein the swelling tape includes one or more perforated holes is provided.

### CROSS CITATION WITH RELATED APPLICATION(S)

This application claims the benefit of Korean Patent Application No. 10-2021-0163386 filed on Nov. 24, 2021 and Korean Patent Application No. 10-2022-0158762 filed on Nov. 23, 2022 in the Korean Intellectual Property Office, the entire contents of which are incorporated herein by reference.

### TECHNICAL FIELD

The present disclosure relates to a jelly-roll electrode assembly and a secondary battery comprising the same.

### BACKGROUND

With the technology development and increased demand for mobile devices, demand for secondary batteries as energy sources have been rapidly increasing. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

Based on the shape of the battery case, a secondary battery is classified into a cylindrical battery where an electrode assembly is mounted in a cylindrical metal can, a prismatic battery where an electrode assembly is mounted in a prismatic metal can, and a pouch-type battery where an electrode assembly is mounted in a pouch type case formed of an aluminum laminate sheet. Among them, the cylindrical battery has an advantage that it has a relatively large capacity and is structurally stable.

The electrode assembly mounted in the battery case is an electricity-generating device enabling charge and discharge that has a cathode/separator/anode laminate structure, and is classified into a jelly-roll type, a stack type, and a stack/folding type. The jelly-roll type is a shape in which a cathode and an anode, each made of an active material-coated long sheet, is rolled with a separator interposed between them, the stack type is a shape in which a plurality of cathodes and a plurality of anodes each having a predetermined size are sequentially stacked in a state where a separator is interposed therebetween, and a stack/folding type is a combination of a jelly-roll type and a stack type. Of these, the jelly-roll-type electrode assembly has advantages that manufacture is easy and the energy density per weight is high.

Therefore, in recent years, as the need for batteries to achieve high capacity and high output has increased, in the case of a cylindrical battery, optimization is underway by changing the thickness of current collectors or separators, and the size or shape of cans, top caps and the like in order to put a large quantity of electrodes in a limited space.

As one of the methods thereof, a method of utilizing copper as an outer tab as an anode current collector has been proposed. That is, the tab and separator on the outside are removed, and the copper current collector physically abuts on the cylindrical so that the current flows out.

Through this method, the input amount of the separator and the input amount of the tap can be reduced, and the outer diameter can be slightly reduced to exhibit the effects of securing space and reducing costs, and the secured space can be utilized to increase capacity or improve output. In addition, since the copper current collector directly abuts on the can, the area of transferring heat is increased, and thus, the heat generation level can be improved.

However, when copper is actually exposed on the outer shell portion, one or two points having a larger outer diameter abut on the can in accordance with the circularity of the jelly roll, which reduces the effect than previously expected.

In order to improve this, the contact level was improved by using a swelling tape that has the property of swelling up when reacting with the electrolyte, but when attaching in the manufacturing process, an air trap is generated, which causes a problem that the outer diameter increases and thus the productivity decreases.

Therefore, it is necessary to develop a jelly-roll electrode assembly and secondary battery technology that can solve these problems.

### DETAILED DESCRIPTION OF THE INVENTION

### Technical Problem

It is an object of the present disclosure to provide a jelly-roll electrode assembly that can eliminate the increase in outer diameter due to an air trap caused by the attachment of the swelling tape, thus improving productivity.

The objects of the present disclosure are not limited to the aforementioned objects, and other objects which are not mentioned herein should be clearly understood by those skilled in the art from the following detailed description and the accompanying drawings.

### Technical Solution

According to one embodiment of the present disclosure, there is provided a jelly-roll electrode assembly comprising a cathode sheet, an anode sheet, and a separator interposed between the cathode sheet and the anode sheet, the cathode sheet, the anode sheet, and the separator being wound together, wherein an outermost side of the jelly-roll electrode assembly includes a non-coated portion on which no active material layer is provided on the anode sheet, wherein a swelling tape is attached to an inner surface of the non-coated portion of the anode sheet facing towards a central part of the jelly-roll electrode assembly, and wherein the swelling tape includes one or more perforated holes.

The anode sheet includes a coated portion having an active material layer provided on the anode sheet, and the swelling tape may be attached to a part of the inner surface of the non-coated portion of the anode sheet and a part of the coated portion of the anode sheet at a boundary surface between the non-coated portion and the coated portion of the anode sheet.

Here, the swelling tape may cover 0.25% to 10% of a total area of the coated portion of the anode sheet.

Alternatively, the swelling tape may be attached to only a part of the inner surface of the non-coated portion of the anode sheet.

Further, the swelling tape may cover 10% to 90% of a total area of the inner surface of the non-coated portion of the anode electrode sheet.

Moreover, the anode sheet includes a coated portion having an active material layer provided on the anode sheet, and the non-coated portion of the anode sheet on which the swelling tape is located may face the coated portion of the anode sheet when wound.

Such a swelling tape may be a single-sided or double-sided tape, wherein the single-sided or double-sided tape is not limited as long as it is a material that has chemical resistance and voltage resistance while being swelled, and may be made of at least one of polyurethane (PU), polyethylene (PE), polycarbonate (PC), polypropylene (PP), or polyimide (PI).

Alternatively, the swelling tape may include an adhesive layer on one surface or opposite surfaces of a fabric substrate, such as, a polyolefin substrate, for example, polyethylene (PE) or polypropylene (PP). The adhesive layer may include at least one of polyacrylate (PA), rubber, or styrene.

Meanwhile. the diameter of the perforated holes in the swelling tape may be 0.1 mm to 3 mm, and the swelling tape may include two or more perforated holes, and the distance between adjacent perforated holes is 1 mm to 10 mm.

The perforated holes may be occupy an area of 10% to 60% of a total area of the swelling tape.

The positions of these perforated holes may extend in a line in a direction perpendicular to the winding direction of the jelly-roll electrode assembly in the swelling tape, or they may extend in two lines in a direction parallel to the winding direction of the jelly roll electrode assembly, or may be located in a central part of the swelling tape.

Meanwhile, according to another embodiment of the present disclosure, there is provided a secondary battery comprising the jelly-roll electrode assembly.

### BRIEF DESCRIPTION OF THE DRAWINGS

FIG. 1 is a perspective view of a jelly-roll electrode assembly according to one embodiment of the present disclosure;

FIG. 2 is a plan view of an anode sheet of a jelly-roll electrode assembly according to one embodiment of the present disclosure:

FIG. 3 is a cross-sectional view of a jelly-roll electrode assembly according to one embodiment of the present disclosure before winding:

FIG. 4 is a cross-sectional view of a jelly-roll electrode assembly according to another embodiment of the present disclosure before winding:

FIG. 5 is a cross-sectional view taken along 5-5′ of FIG. 1; and

FIG. 6 are plan views of a swelling tape according to one embodiment of the present disclosure.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

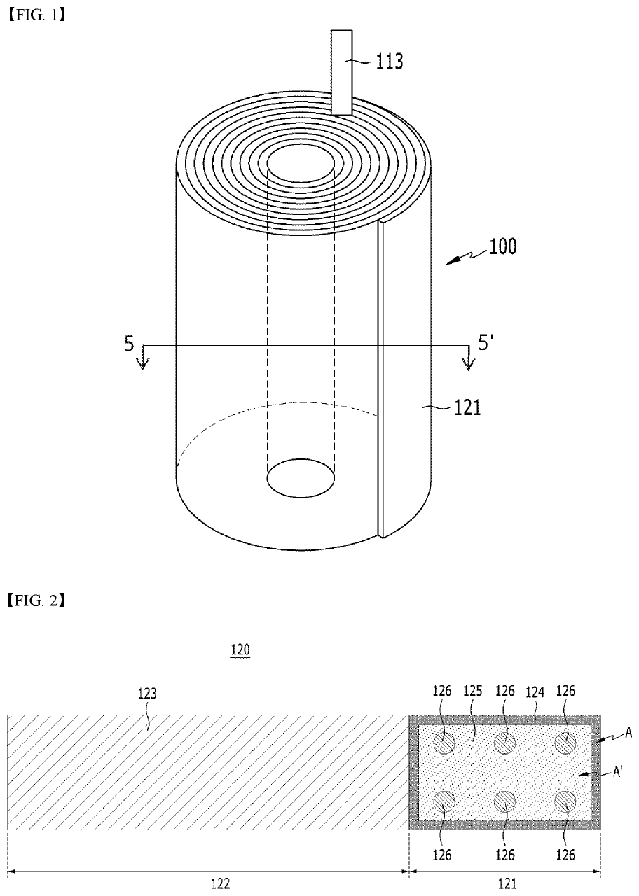

FIG. 1 is a perspective view of a jelly-roll electrode assembly according to one embodiment of the present disclosure.

Referring to FIG. 1, the jelly-roll electrode assembly 100 according to one embodiment of the present disclosure may have a shape in which a cathode sheet, an anode sheet, and a separator interposed between the cathode sheet and the anode sheet are wound together.

At this time, the cathode tab 113 may be formed on the cathode sheet, which may then be electrically connected to the cap assembly or the like of the cylindrical battery to form a cathode terminal.

Meanwhile, the outermost side of the jelly-roll electrode assembly 100 is wound with a non-coated portion 121 on which no active material layer is formed on the anode sheet, and this non-coated portion 121 then comes into contact with the inner wall surface of the can of the secondary battery. Therefore, the non-coated portion 121 of the anode sheet functions as a terminal and can be electrically and directly connected to the can, which is a cylindrical secondary battery case, and thus, may not require a separate anode tab.

In addition, since the jelly-roll electrode assembly 100 may not be formed with a separator on its outermost side, it is possible to achieve the effect of reducing the outer diameter, thereby securing the internal space of the battery, increasing the capacity, improving the energy density, and improving the battery performance and effect.

However, as described above, when the non-coated portion 121 of the anode sheet is actually exposed to the outer shell portion, there is a problem that one or two points having a larger outer diameter abut on the can in accordance with the circularity of the jelly roll, which reduces the effect than previously expected. Therefore, in the present disclosure, in order to improve this problem, a swelling tape having the property of swelling up when reacting with the electrolyte is applied.

At this time, the swelling tape has a structure attached to the inner surface toward the central part of the jelly-roll electrode assembly 100, rather than the outer shell of the non-coated portion 121 of the anode sheet of the jelly-roll electrode assembly 100, so that the non-coated portion 121 of the outermost side anode sheet can then contact the cylindrical secondary battery case as a whole, without affecting the capacity.

Therefore, such a swelling tape is not shown in FIG. 1.

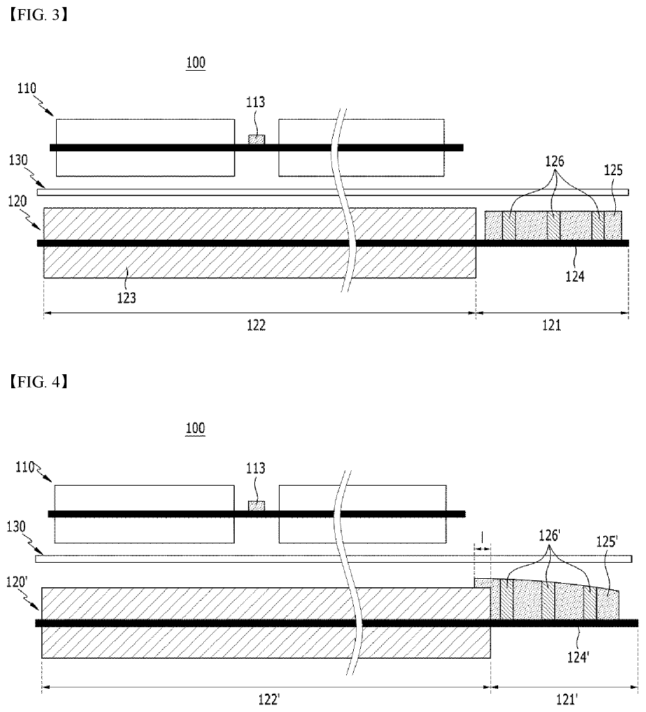

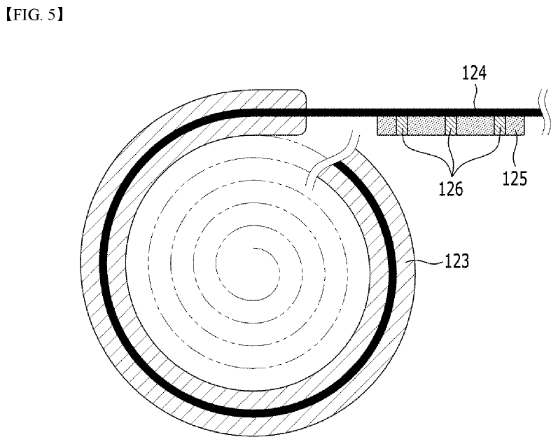

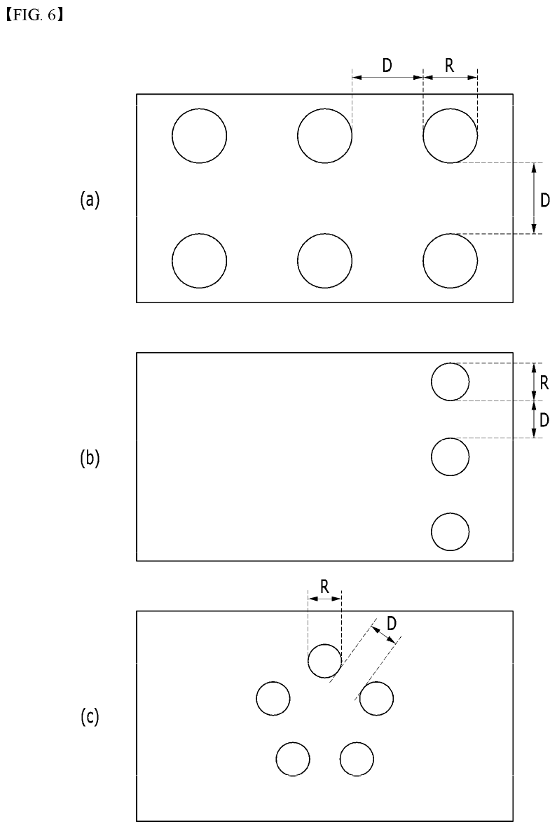

Meanwhile, in order to specifically describe the swelling tape according to the present disclosure, FIG. 2 illustrates a plan view of the anode sheet 120 before winding in the jelly-roll electrode assembly 100 of FIG. 1, FIG. 3 illustrates a cross-sectional view of the jelly-roll electrode assembly 100 of FIG. 1 before winding, FIG. 4 illustrates a cross-sectional view of a jelly-roll electrode assembly 100 before winding according to another embodiment, and FIG. 5 illustrates a cross-sectional view taken along 5-5′ of the jelly roll electrode assembly 100 of FIG. 1.

First, referring to FIGS. 2 and 3, the cathode sheet 110 includes a coated portion on which a cathode active material layer is formed and a non-coated portion on which no cathode active material layer is formed, and has a structure in which the non-coated portion is provided between the coated portions and the cathode tab 113 is attached to the non-coated portion.

Further, a separator 130 is interposed between the cathode sheet 110 and the anode sheet 120.

The anode sheet 120 includes a coated portion 122 in which an active material layer 123 is formed on the anode current collector 124, and a non-coated portion 121 on which no active material layer 123 is formed, wherein the non-coated portion 121 is located on one side and is wound around the outermost side, thereby serving as an anode terminal.

Meanwhile, a swelling tape 125 is attached to the winding inner surface of the non-coated portion 121.

Here, the swelling tape 125 may be formed as an area (A′) covering 10% to 90% of the total area (A) of the inner surface of the non-coated portion 121 of the anode sheet 120.

Further, the swelling tape 125 may be formed only on a part of the inner surface of the non-coated portion 121 so as not to overlap with the coated portion 122 of the anode sheet 120.

Alternatively, referring to FIG. 4, the swelling tape 125′ may be attached to a part of the inner surface of the non-coated portion 121′ of the anode sheet 120′, and a part of the coated portion 122′ of the anode sheet 120 in the direction of the coated portion 122′ of the anode sheet 120′ at the boundary surface between the non-coated portion 121′ and the coated portion 122′ in which an active material layer is formed on the anode current collector 124′ of the anode sheet. At this time, it may be formed within a length (1) range that does not overlap with the active material layer of the facing cathode sheet 110. For example, the swelling tape may cover the coated portion of the anode sheet in the range of 0.25% to 10%, specifically 0.5% to 5% of the total area of the coated portion of the anode sheet.

However, in either case, the non-coated portion 121 of the outermost side anode sheet 120 on which the swelling tape 125 is formed faces the active material layer 123 of the anode sheet 120 located on the inner side, that is, the coated portion 122.

Therefore, since the swelling tape 125 is formed on a portion where the active material layer 123 does not face the cathode, that is, a portion that does not contribute to the capacity, the problem of capacity does not occur. At the same time, since the swelling tape 125 is formed on the inner side of the current collector 124 of the anode sheet 120 at the outermost side of the jelly-roll electrode assembly 100, the current collector 124 can contact the can of the cylindrical battery case as a whole, and thus, the effect intended by the present disclosure can be achieved without diminishing the improvement in conductivity and heat generation level.

Meanwhile, the swelling tape 125 has a property of expanding its volume when it absorbs electrolyte, and may be a single-sided or double-sided tape.

At this time, the single-sided or double-sided tape is not limited as long as it is a material that has chemical resistance and voltage resistance while being swelled. For example, it may be made of at least one selected from the group consisting of polyurethane(PU), polyethylene(PE), polycarbonate(PC), polypropylene(PP), and polyimide(PI).

Alternatively, the swelling tape 125 may have a structure in which an adhesive layer is formed on one side or both sides of the fabric substrate.

Here, the fabric substrate may be a polyolefin-based substrate, for example, polyethylene (PE) or polypropylene (PP), and the adhesive layer may include one or more materials selected from the group consisting of polyacrylate (PA), rubber, and styrene.

Meanwhile, such a swelling tape 125 includes one or more perforated holes 126, and a swelling tape 125′ includes one or more perforated holes 126′.

The perforated holes 126 are holes that penetrate through the swelling tape 125 in the thickness direction.

Therefore, air trap that may be generated while attaching the swelling tape 125 to the non-coated portion 121 can be eliminated to prevent an increase in the outer diameter of the jelly-roll electrode assembly 100 that will occur therefrom, thereby improving productivity.

The shape, formation position, size and the like of the perforated holes 126 are not particularly limited as long as they are formed in a shape, formation position, and size capable of eliminating an air trap generated during attachment of the swelling tape 125.

However, in order to eliminate the air trap more effectively, the formation position, size or the like are affected.

Specifically, in order to specifically describe the perforated holes 126 formed in the swelling tape 125, FIG. 6 shows examples of the swelling tape 125.

Referring to FIG. 6, a plurality of perforated holes 126 may be formed in the swelling tape 125. Specifically, the swelling tape 125 may have two or more perforated holes 126, and can be appropriately selected in consideration of the degree of air trap and the increase in contact area with the battery case due to the swelling tape 125.

At this time, the diameter (R) of the perforated holes 126 may be 0.1 mm to 3 mm, specifically 1 mm to 3 mm.

If the diameter is too small outside the above range, it is not easy to eliminate the air trap, and if the diameter is too large, the effect due to the application of the swelling tape cannot be sufficiently achieved, which is not preferable.

In addition, the distance D between the perforated holes 126 may be 1 mm to 10 mm, specifically 3 mm to 10 mm.

If the distance is too small outside the above range, the adjacent perforated holes 126 are torn apart, the size of the perforated holes 126 may increase, and the effect due to the application of the swelling tape 125 cannot be sufficiently achieved, and if the distance is too large, it is not easy to discharge the air trapped therebetween, which is not preferable.

In addition, the area occupied by the perforated holes 126 may be 10% to 60% of the total area of the swelling tape 125. If the area is too small outside the above range, it is not easy to discharge the trapped air, and if the area is too large, the effect due to the application of the swelling tape 125 cannot be achieved, which is not preferable.

Meanwhile, these perforated holes 126 may be formed before attachment, simultaneously with attachment, or after attachment of the swelling tape 125, and can be formed in a portion where air trap is well formed or a portion of not overlapping with the device used for such attachments, depending on the method of attachment.

Specifically, the perforated holes 126 may be attached to the non-coated portion of the anode sheet in a state in which they are first formed on the swelling tape 125 before attachment, or it may be formed near the portion where air is trapped simultaneously with being attached to the anode sheet, or it may be separately formed near the portion where air is trapped after the swelling tape 125 is attached.

Meanwhile, considering the method of attaching the swelling tape 125, the perforated holes 126 may be formed in a line at both ends in a direction parallel to the winding direction of the jelly-roll electrode assembly (see FIG. 6(a)), and may be formed in a line on the winding inside in a direction perpendicular to the winding direction of the jelly roll electrode assembly (FIG. 6(b)), and may be formed in the central part of the swelling tape 125 (FIG. 6(c)).

However, it is not limited to this structure, and can be formed at various positions.

Moreover, although the perforated holes 126 are shown in a circular shape in the figures, but the shape is not limited, and can be formed in a polygonal shape.

When the swelling tape 125 includes the perforated holes 126 in this way, as distortion occurs due to compression of the roller in a state where the swelling tape 125 is not properly attached when attaching the swelling tape 125, it can effectively discharge the trapped air, and thus can prevent an increase in the outer diameter of the jelly-roll electrode assembly, and the effect of improving productivity can be achieved.

The composition, structure and the like of the cathode sheet, anode sheet, and separator constituting other jelly-roll electrode assemblies are known in the art, and thus, a detailed description is omitted herein.

Meanwhile, the present disclosure provides a secondary battery including the jelly-roll electrode assembly.

At this time, the secondary battery may be a cylindrical secondary battery or a prismatic secondary battery in which the jelly-roll electrode assembly is mounted in a can.

Such a secondary battery is also known in the art, and thus, a detailed description thereof is omitted herein.

Although preferred embodiments of the present disclosure have been described in detail above with reference to the accompanying drawings, the scope of the present disclosure is not limited thereto, and various modifications and improvements can be made by those skilled in the art using the basic concepts of the present disclosure which are defined in the appended claims, which also fall within the scope of the present disclosure.

### DESCRIPTION OF REFERENCE NUMERALS

100: jelly-roll electrode assembly
110: cathode sheet
120: anode sheet
130: separator
113: anode tab
121 non-coated portion of anode sheet
122: coated portion of anode sheet
125: swelling tape
126: perforated holes

### INDUSTRIAL APPLICABILITY

According to embodiments, the jelly-roll electrode assembly of the present disclosure includes a swelling tape on the inner surface of the battery non-coated portion of the outermost side anode sheet, and includes perforated holes through which the swelling tape can discharge trapped air, whereby an increase in the outer diameter of the jelly-roll electrode assembly caused by air trap can be prevented, and the productivity can be improved.

The invention claimed is:

1. A jelly-roll electrode assembly comprising a cathode sheet, an anode sheet, and a separator interposed between the cathode sheet and the anode sheet,
Wherein the cathode sheet, the anode sheet, and the separator are wound together,
wherein an outermost side of the jelly-roll electrode assembly includes a non-coated portion on which no active material layer is provided on the anode sheet,
wherein a swelling tape is attached to an inner surface of the non-coated portion of the anode sheet facing towards a central part of the jelly-roll electrode assembly, and
wherein the swelling tape includes one or more perforated holes.

2. The jelly-roll electrode assembly according to claim 1, wherein:
the anode sheet includes a coated portion having an active material layer provided on the anode sheet, and
the swelling tape is attached to a part of the inner surface of the non-coated portion of the anode sheet and a part of the coated portion of the anode sheet at a boundary surface between the non-coated portion and the coated portion of the anode sheet.

3. The jelly-roll electrode assembly according to claim 2, wherein:
the swelling tape covers 0.25% to 10% of a total area of the coated portion of the anode sheet.

4. The jelly-roll electrode assembly according to claim 1, wherein:
the swelling tape is attached to only a part of the inner surface of the non-coated portion of the anode sheet.

5. The jelly-roll electrode assembly according to claim 1, wherein:
the swelling tape covers 10% to 90% of a total area of the inner surface of the non-coated portion of the anode electrode sheet.

6. The jelly-roll electrode assembly according to claim 1, wherein:
the anode sheet includes a coated portion having an active material layer provided on the anode sheet, and
the non-coated portion of the anode sheet on which the swelling tape is located faces the coated portion of the anode sheet when wound.

7. The jelly-roll electrode assembly according to claim 1, wherein:
the swelling tape is a single-sided or double-sided tape.

8. The jelly-roll electrode assembly according to claim 7, wherein:
the single-sided or double-sided tape is made of at least one of polyurethane (PU), polyethylene (PE), polycarbonate (PC), polypropylene (PP), or polyimide (PI).

9. The jelly-roll electrode assembly according to claim 1, wherein:
the swelling tape includes an adhesive layer on one surface or opposite surfaces of a polyolefin-based substrate.

10. The jelly-roll electrode assembly according to claim 9, wherein:
the adhesive layer includes at least of polyacrylate (PA), rubber, or styrene.

11. The jelly-roll electrode assembly according to claim 1, wherein:
a diameter of each of the one or more perforated holes is 0.1 mm to 3 mm.

12. The jelly-roll electrode assembly according to claim 1, wherein:
one or more perforated holes includes two or more perforated holes, and
the distance between adjacent perforated holes is 1 mm to 10 mm.

13. The jelly-roll electrode assembly according to claim 1, wherein:
the one or more perforated holes occupy an area of 10% to 60% of a total area of the swelling tape.

14. The jelly-roll electrode assembly according to claim 1, wherein:
the one or more perforated holes extend in a line in a direction perpendicular to a winding direction of the jelly-roll electrode assembly in the swelling tape.

15. The jelly-roll electrode assembly according to claim 1, wherein:
the one or more perforated holes extend in two lines in a direction parallel to the winding direction of the jelly-roll electrode assembly.

16. The jelly-roll electrode assembly according to claim 1, wherein:
the one or more perforated holes are located in a central part of the swelling tape.

17. A secondary battery comprising the jelly-roll electrode assembly according to claim 1.
